(19) United States
(12) Patent Application Publication
(10) Pub. No.: US 2013/0249764 A1
(43) Pub. Date: Sep. 26, 2013

(54) COMPACT PLANAR INVERTED F-ANTENNA FOR MULTIBAND COMMUNICATION

(71) Applicants: Rony E. Amaya, Kanata (CA); Yazi Cao, Ottawa (CA)

(72) Inventors: Rony E. Amaya, Kanata (CA); Yazi Cao, Ottawa (CA)

(73) Assignee: Her Majesty the Queen in Right of Canada, as represented by the Minister of Industry, Ottawa (CA)

(21) Appl. No.: 13/428,675

(22) Filed: Mar. 23, 2012

(51) Int. Cl. H01Q 9/04; H01Q 1/48

(52) U.S. Cl. 343/845; 343/700 MS

(57) ABSTRACT

A multi-band antenna for sending/receiving wireless communication signals in a plurality of frequency bands. The multi-band antenna has a feed element for sending/receiving signals associated with the wireless communication signals. A stepped-impedance structure is connected to the feed element. The stepped-impedance structure has a plurality of concatenated stepped-impedance elements with each stepped-impedance element having a predetermined impedance and a predetermined electrical length associated with a resonance mode for sending/receiving wireless communication signals in a respective frequency band of the plurality of frequency bands.

### FIELD

The present invention relates to wireless communication antennas, and more particularly to a multiband antenna for wireless communication devices.

### BACKGROUND

Wireless communication devices typically use multiband antennas to transmit and receive wireless signals in multiple wireless communication frequency bands such as GSM900/1800, ISM bands, GPS, and IMT satellite communication. Because of its compact size and multiband performance, a Planar Inverted F-Antenna (PIFA) is preferred for multiband antenna for wireless communication devices.

Unfortunately, PIFAs exhibit problems related to the radiating branches which not only generate lower resonant modes used for the signal transmission/reception but also a plurality of higher order resonant modes. These unwanted higher order resonant modes are difficult to control and substantially impede the tuning of the multiband antenna.

Furthermore, the radiation caused by the higher order resonant modes substantially affects the performance of the low-noise amplifier in the receiver and can even pose the risk of saturating the same, as well as severely degrades the performance of the power amplifier.

It is desirable to provide a multiband antenna for wireless communication devices that is capable of sending/receiving wireless communication signals in a plurality of frequency bands.

It is also desirable to provide a multiband antenna for wireless communication devices that has substantially reduced radiation associated with unwanted higher order resonant modes.

It is also desirable to provide a multiband antenna for wireless communication devices that is compact and simple to implement.

### SUMMARY

Accordingly, one object of the present invention is to provide a multiband antenna for wireless communication devices that is capable of sending/receiving wireless communication signals in a plurality of frequency bands.

Another object of the present invention is to provide a multiband antenna for wireless communication devices that has substantially reduced radiation associated with unwanted higher order resonant modes.

Another object of the present invention is to provide a multiband antenna for wireless communication devices that is compact and simple to implement.

According to one aspect of the present invention, there is provided a multi-band antenna for sending/receiving wireless communication signals in a plurality of frequency bands. The multi-band antenna has a feed element for sending/receiving signals associated with the wireless communication signals. A stepped-impedance structure is connected to the feed element. The stepped-impedance structure has a plurality of concatenated stepped-impedance elements with each stepped-impedance element having a predetermined impedance and a predetermined electrical length associated with a resonance mode for sending/receiving wireless communication signals in a respective frequency band of the plurality of frequency bands.

According to one aspect of the present invention, there is provided a multi-band antenna for sending/receiving wireless communication signals in a plurality of frequency bands. An interdigitated coupled feed element for transmitting signals associated with the wireless communication signals is disposed on a dielectric substrate. A stepped-impedance structure is disposed on the dielectric substrate and connected to the feed element. The stepped-impedance structure has a plurality of concatenated folded stripe lines with each folded stripe line having a predetermined impedance and a predetermined electrical length associated with a resonance mode for sending/receiving wireless communication signals in a respective frequency band of the plurality of frequency bands. A shorted element is disposed on the dielectric substrate with the shorted element being connected to one of the folded stripe lines at a first end and connected to a ground plane at a second end.

One advantage of the present invention is that it provides a multiband antenna for wireless communication devices that is capable of sending/receiving wireless communication signals in a plurality of frequency bands.

A further advantage of the present invention is that it provides a multiband antenna for wireless communication devices that has substantially reduced radiation associated with unwanted higher order resonant modes.

A further advantage of the present invention is that it provides a multiband antenna for wireless communication devices that is compact and simple to implement.

### BRIEF DESCRIPTION OF THE DRAWINGS

One embodiment of the present invention is described below with reference to the accompanying drawings, in which:

FIGS. 1a and 1b are simplified block diagrams illustrating a perspective top view and a detailed top view, respectively, of a multi-band antenna according to one embodiment of the invention;

FIG. 2 is a simplified diagram illustrating simulated and measured return loss of an implementation of the multi-band antenna according to an embodiment of the invention;

FIGS. 3a to 3c are simplified block diagrams illustrating a top view, a side view, and a bottom view, respectively, of a multi-band antenna according to another embodiment of the invention; and,

FIGS. 4a and 4b are simplified block diagrams illustrating top views of multi-band antennas according to other embodiments of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

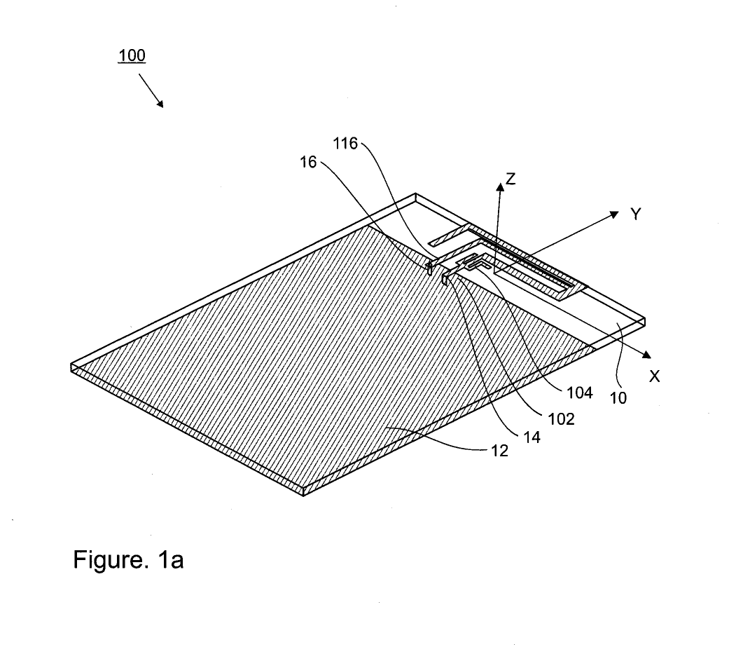

Referring to FIGS. 1a and 1b, multi-band antenna 100 for sending/receiving wireless communication signals in a plurality of frequency bands according to one embodiment of the invention is provided. The multi-band antenna 100 can be implemented as a PIFA—as described hereinbelow—but, as will become evident to one skilled in the art, is not limited thereto. The multi-band antenna 100 is disposed on the surface of dielectric substrate 10 such as, for example, a FR4 dielectric substrate, having a ground plane 12 disposed on a bottom surface portion thereof. A radiating portion of the multi-band antenna 100 can be disposed on a top surface portion of the dielectric substrate 10 above a ground-clear area of the dielectric substrate 10.

Feed element 102 is electrically connected via feed port 14 to circuitry of the wireless device for providing/receiving signals associated with the wireless communication signals. The radiating portion of the multi-band antenna 100 can be coupled to the feed element 102 via interdigitated coupler 104. The interdigitated coupler 104 forms, for example, a three-finger structure with one end portion having substantially an L-shape and the other end portion portions forming open ends. Alternatively, the interdigitated coupler 104 comprises more than three fingers and/or different shapes such as, for example, a V-shape or an arc-shape. The interdigitated coupler 104 enhances signal coupling and provides increased flexibility for impedance matching in the antenna design.

Further alternatively, the radiating portion of the multi-band antenna 100 is coupled to the feed element 102 in a different fashion such as, for example, in a direct connection, thus omitting a coupling element.

The radiating portion of the multi-band antenna 100 is designed as a stepped-impedance structure connected to the feed element 102 via the interdigitated coupler 104. The stepped-impedance structure comprises a plurality of concatenated stepped-impedance elements, for example, five stepped-impedance elements 106, 108, 110, 112, and 114, as illustrated in FIG. 1b. Each stepped-impedance element has a predetermined impedance Z and a predetermined electrical length θ associated with a resonance mode for sending/receiving wireless communication signals in a respective frequency band of the plurality of frequency bands. It is noted that the effective impedance Z and effective electrical length θ of each stepped-impedance element is also dependent on the characteristics of adjacent stepped-impedance elements, providing added flexibility and potential for miniaturization. For example, the length of a stepped-impedance element can be substantially smaller than the expected half-wavelength, if the characteristics of adjacent stepped-impedance elements are designed accordingly. The stepped-impedance structure can comprise a plurality of folded stripe lines 106, 108, 110, 112, and 114, as illustrated in FIG. 1b.

Shorted element 116 is connected at a first end to one of the stepped-impedance elements—for example, stepped-impedance element 110, as illustrated in FIGS. 1a and 1b—and to the ground plane 12 at a second end. To connect the shorted element 116 disposed on the top surface of the dielectric substrate 10 to the ground plane 12 disposed on the bottom surface of the dielectric substrate 10 via aperture 16 is disposed in the dielectric substrate 10 for accommodating the shorted element 116 therein. Optionally, the shorted element 116 is connected to another stepped-impedance element such as, for example, stepped-impedance element 108 or 112. Connecting the shorted element 116 to another stepped-impedance element has a minor effect on the return loss of the multi-band antenna 100 and possibly necessitates re-design of the antenna.

The multi resonance mode property of the stepped-impedance structure is determined using generalized transmission line theory and is characterized by the impedance Z and the electrical length θ of each of the stepped-impedance elements. While each stepped-impedance element is designed for sending/receiving wireless communication signals in a respective frequency band of the plurality of frequency bands, the effective impedance Z and effective electrical length θ of each stepped-impedance element is also dependent on the characteristics of adjacent stepped-impedance elements, i.e. the stepped-impedance structure is determined as a whole. For example, adding a new stepped-impedance element affects the characteristics of all other stepped-impedance elements of the stepped-impedance structure.

The design of the radiating portion of the multi-band antenna 100 as a stepped-impedance structure enables substantial control of high resonance modes by adjusting the impedances Z and electrical lengths θ of the stepped-impedance elements. Furthermore, the design as a stepped-impedance structure enables suppressing/filtering of unwanted higher order resonance modes.

In an exemplary implementation the multi-band antenna 100 has been realized as a PIFA—as illustrated in FIGS. 1a and 1b for sending/receiving wireless communication signals in five frequency bands centered at: 915 MHz; 1575 MHz; 2400 MHz; 3200 MHz; and 5800 MHz to cover: ISM 915/2400/5800 tri-bands; GPS band; and IMT C-band. The ground plane 12—73.6 mm long and 54 mm wide—is printed on the bottom surface of the FR4 dielectric substrate 10. The radiating portion of the multi-band antenna 100 is formed by printing or etching on the top surface of the dielectric substrate 10—which is 85.6 mm long, 54 mm wide, and 1 mm thick.

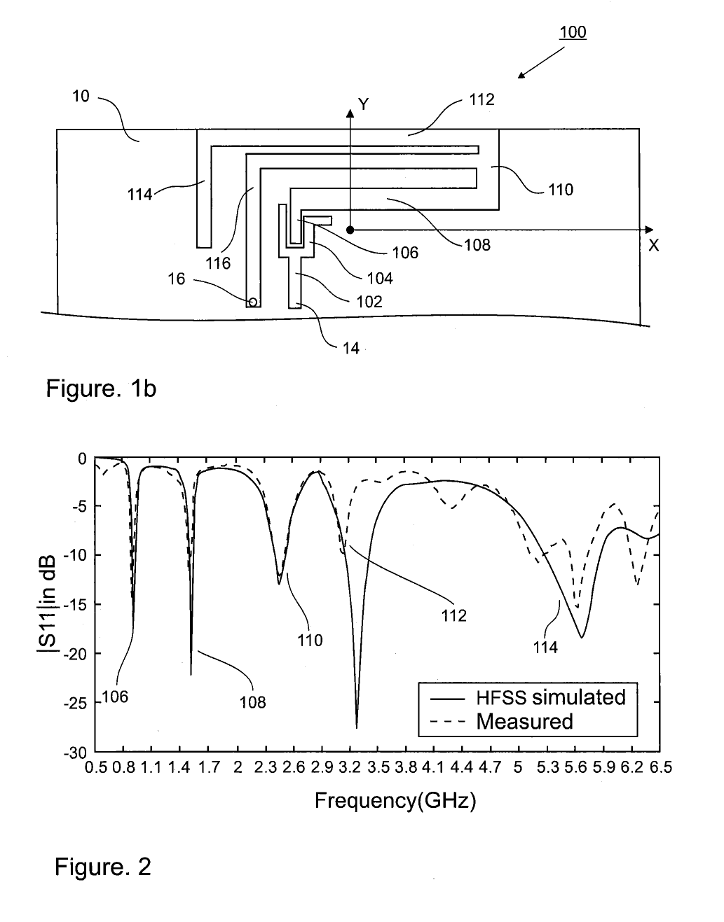

FIG. 2 illustrates simulated and measured return loss for the multi-band antenna 100 as implemented. The experimental result illustrates that the multi-band antenna 100 sends/receives wireless communication signals in five frequency bands centered at: 915 MHz; 1575 MHz; 2400 MHz; 3200 MHz; and 5800 MHz, associated with the stepped-impedance elements: 106; 108; 110; 112; and 114, respectively. The experimental result also illustrates that the five frequency bands are tuned in a substantially optimal fashion absent unwanted higher order resonance modes. Therefore, the multi-band antenna 100 enables implementation of an antenna for sending/receiving wireless communication signals in a plurality of frequency bands covering major frequency bands used in state of the art wireless communication. Furthermore, the stepped-impedance structure of the multi-band antenna 100 enables design and implementation of a multi-band antenna in a substantially compact and simple fashion using standard technology.

In the exemplary implementation the multi-band antenna 100 was designed having five stepped-impedance elements for sending/receiving wireless signals in five respective frequency bands, but is not limited thereto. In state of the art technology, the limit to the number of implementable frequency bands is determined by the losses in the metallic interconnects used. State of the art low loss dielectric substrates such as, for example, Low-Temperature Co-fired Ceramics (LTCC) enable design of multi-band antennas for sending/receiving in up to approximately 12 frequency bands, while dielectric substrates exhibiting higher losses such as, for example, FR4, enable design of multi-band antennas for sending/receiving in a smaller number of frequency bands. The implementable maximum frequency for sending/receiving wireless signals is depending on the dielectric substrate used with the maximum frequency being approximately 10 GHz for state of the art dielectric substrates such as, for example, LTCCs. The multi-band antenna 100 is implementable for simultaneously sending/receiving wireless signals in different frequency bands provided the circuitry connected to the multi-band antenna 100 is capable of operating in full-duplex mode.

In the exemplary implementation the multi-band antenna 100 was designed having five concatenated stepped-impedance elements with the stepped-impedance elements being arranged in order of increased center frequency of the different frequency bands with stepped-impedance element 106 being associated with the lowest center frequency as illustrated in FIG. 2. It is noted that the design of the multi-band antenna 100 is not limited thereto, i.e. the stepped-impedance elements can be arranged in an arbitrary fashion, for example, in dependence upon an available surface area on the dielectric substrate 10.

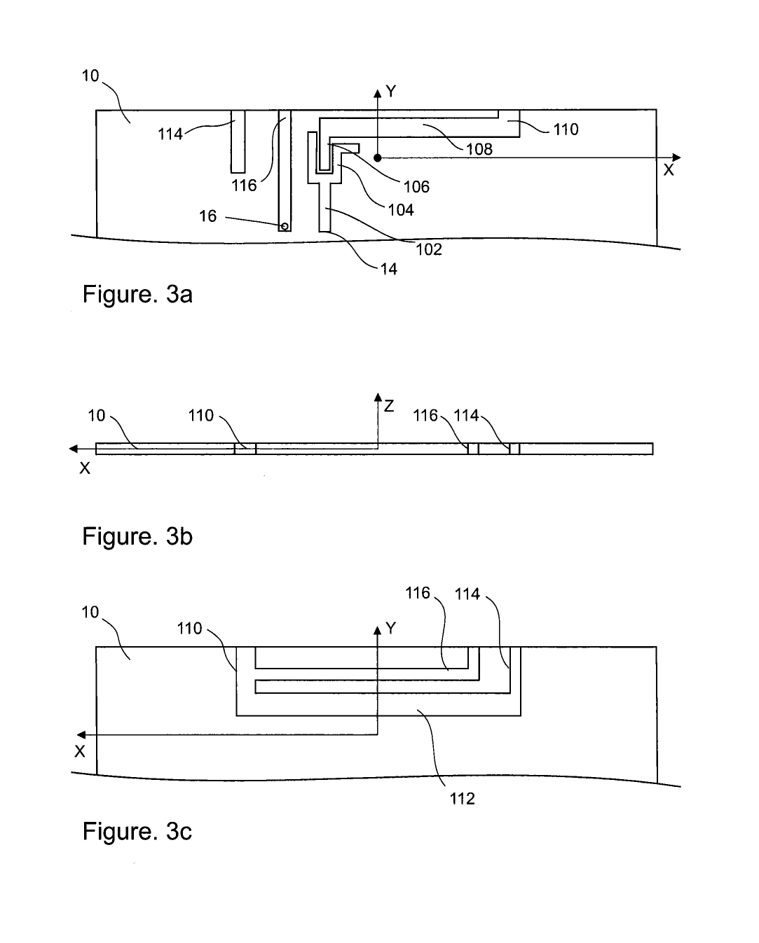

The implementation the multi-band antenna 100 is not limited to the stepped-impedance elements being disposed on a single surface of the dielectric substrate 10. For example, depending on the surface area available on the dielectric substrate 10, the stepped-impedance elements are disposed on different surfaces—for example, the top surface, a side surface, and the bottom surface—of the dielectric substrate 10, as illustrated in FIGS. 3a to 3c.

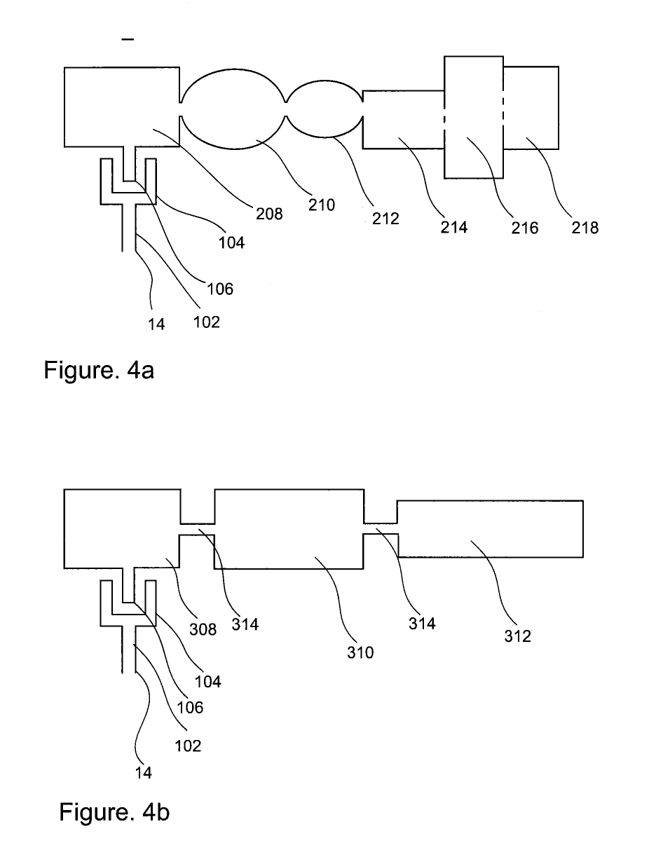

The stepped-impedance elements are implementable in a plurality of shapes such as, for example, circles, ellipses, rectangles, and triangles, with the shapes being arranged in an arbitrary order, as illustrated in FIG. 4b with stepped-impedance elements 208, 210, 212, 214, 216, and 218.

Optionally, a plurality of stepped-impedance structures is branched off a same feed line with each stepped-impedance structure being capable of sending/receiving wireless signals in a plurality different frequency bands up to a maximum number of different frequency bands depending on the dielectric substrate used.

Further optionally, as illustrated in FIG. 4b, the stepped-impedance elements 308, 310, and 312 are not directly concatenated but connected via connecting elements 314.

The present invention has been described herein with regard to certain embodiments. However, it will be obvious to persons skilled in the art that a number of variations and modifications can be made without departing from the scope of the invention as described herein.

What is claimed is:

1. A multi-band antenna for sending/receiving wireless communication signals in a plurality of frequency bands comprising:
a feed element for sending/receiving signals associated with the wireless communication signals; and,
a stepped-impedance structure connected to the feed element, the stepped-impedance structure having a plurality of concatenated stepped-impedance elements, each stepped-impedance element having a predetermined impedance and a predetermined electrical length associated with a resonance mode for sending/receiving wireless communication signals in a respective frequency band of the plurality of frequency bands.

2. A multi-band antenna as defined in claim 1, wherein the stepped-impedance structure comprises a plurality of folded stripe lines with each stripe line being associated with a respective stepped-impedance element.

3. A multi-band antenna as defined in claim 2, comprising a shorted element connected to one of the stepped-impedance elements at a first end and connected to a ground plane at a second end.

4. A multi-band antenna as defined in claim 2, wherein the feed element comprises an interdigitated coupler.

5. A multi-band antenna as defined in claim 2, wherein the multi-band antenna forms a planar inverted F-antenna.

6. A multi-band antenna as defined in claim 1, wherein the stepped-impedance structure comprises more than two stepped-impedance elements for sending/receiving wireless communication signals in more than two frequency bands.

7. A multi-band antenna for sending/receiving wireless communication signals in a plurality of frequency bands comprising:
an interdigitated coupled feed element disposed on a dielectric substrate, the interdigitated coupled feed element for transmitting signals associated with the wireless communication signals;
a stepped-impedance structure disposed on the dielectric substrate and connected to the feed element, the stepped-impedance structure having a plurality of concatenated folded stripe lines, each folded stripe line having a predetermined impedance and a predetermined electrical length associated with a resonance mode for sending/receiving wireless communication signals in a respective frequency band of the plurality of frequency bands; and
a shorted element disposed on the dielectric substrate, the shorted element being connected to one of the folded stripe lines at a first end and connected to a ground plane at a second end.

8. A multi-band antenna as defined in claim 7, wherein the interdigitated coupled feed element and the stepped-impedance structure are disposed on a first surface of the dielectric substrate, and wherein the ground plane is disposed on a second opposite surface of the dielectric substrate.

9. A multi-band antenna as defined in claim 8, wherein the stepped-impedance structure comprises more than two folded stripe lines for sending/receiving wireless communication signals in more than two frequency bands.

10. A multi-band antenna as defined in claim 8, wherein the stepped-impedance structure comprises five folded stripe lines for sending/receiving wireless communication signals in frequency bands centered at 915 MHz, 1575 MHz, 2400 MHz, 3200 MHz and 5800 MHz.
